(19) United States
(12) Patent Application Publication
(10) Pub. No.: US 2016/0052445 A1
(43) Pub. Date: Feb. 25, 2016

(54) ROOF RACK WITH INTEGRATED LIGHT

(71) Applicant: BIGTIME AUTO PARTS MFG. CO., LTD., Tainan City (TW)

(72) Inventor: Yao Hung HUANG, Tainan City (TW)

(21) Appl. No.: 14/531,898

(22) Filed: Nov. 3, 2014

(30) Foreign Application Priority Data
Aug. 20, 2014 (TW) 103214883
Aug. 20, 2014 (TW) 103304895
Sep. 20, 2014 (JP) 2014-005040
Sep. 26, 2014 (DE) 202014104627.5

(51) Int. Cl. B60Q 1/44; B60R 9/04; B60Q 1/26

(52) U.S. Cl. CPC B60Q 1/44; B60Q 1/2611; B60R 9/04

(57) ABSTRACT

A roof rack with integrated light includes a mounting frame section with an integrated receptacle in the front or rear side. This mounting frame section is mounted to the roof of a vehicle using mounting elements that connect it directly to the roof or other sections of the roof rack. A light source suitable for automotive applications is located in the receptacle and covered with a lens. This lens covers the majority of the length of the frame section but does not extend above the top of the frame section. The system can be powered by connecting it to the vehicles system or a battery.

### RELATED APPLICATIONS

The present application claims priority to Taiwanese Patent Application Nos. 103304895 and 103214883, filed on Aug. 20, 2014; Japanese Patent Application No. 2014-005040, filed on Sep. 20, 2014; and German Patent Application No. 202014104627.5, filed on Sep. 26, 2014, which are all hereby incorporated herein by reference in their entireties.

### FIELD OF THE INVENTION

The embodiments disclosed herein relate to vehicle roof racks, and more particularly to vehicle roof rack lighting systems.

### BACKGROUND OF THE INVENTION

Conventional roof rack systems allow cumbersome objects to be secured to the top of the vehicle. Such conventional systems may include attached spotlights to provide additional illumination ahead of the vehicle. These spotlights are known to extend outwardly and forward from the roof rack, often above the top of the roof rack itself. By extending outwardly so much from the roof rack, such forward lights typically prevent certain types of objects from being secured to the roof rack, such as cargo carriers, for example, that may extend forward of the roof rack's cross bars. Furthermore, by using a series of discrete lights, such systems provide inconsistent illumination of the area ahead of the vehicle, rather than a uniform illumination more useful to the driver.

Additionally, passenger vehicles generally have two rear brake lights at the respective sides of the vehicle, and a third rear brake light centrally located above the rear hood or hatch. This third light is typically positioned so as to be at the eye level of a driver of a standard vehicle following the lighted vehicle, in order to allow quicker recognition of the vehicle braking, thereby helping to prevent accidents. Being located for the typical passenger vehicle, however, these central brake lights are lower than the average eye level of a driver of a passenger truck or SUV, and those even on trucks and SUVs are much lower than the eye level of drivers of semis and other large vehicles.

For driving safety, vehicles are normally provided at the rear with headlights, brake lights and flashing lights. In the darkness, the brake lights illuminate red while driving. During braking, the brake light glows an intense red. When turned on, the flashing lights can be yellow or other colors. A vehicle's lights allow other road users to see the vehicle, recognize the direction of travel as well as the intention of the equipped vehicle. However, a vehicle's lighting is generally found only at designated locations, usually the four corners of a car body. The warning provided to other road users is limited because there may be many blind spots where the persons and vehicles located laterally of the vehicle cannot see the lights. Also, many of the vehicle lights are usually mounted below the line of sight, especially for drivers of larger vehicles. Further, some lights may be obscured by other equipment such as an aforementioned trunk mounted bike rack. In some cases, if two vehicles are sufficiently close to each other, the driver of the rear vehicle cannot easily see the lighting of the front vehicle, leading to accidents.

The various embodiments described below allow for improved roof rack lighting systems.

### SUMMARY OF THE INVENTION

The present embodiments address and overcome the limitations of conventional roof rack lighting systems by integrating the light source into the roof rack itself and thereby preventing the lights from obstructing the loading of cargo, but also structurally protecting the lights from heavy cargo loaded on the roof rack. Additionally, embodiments are capable of providing more uniform illumination of the area ahead of the vehicle, while increasing visibility of the vehicle to other drivers.

In an embodiment, the present roof rack lighting system includes a brake light integrated with the roof rack that can be connected to the vehicle's braking light system to aid warning of trailing drivers.

In an embodiment, the present roof rack lighting system can also be integrated and/or retrofitted onto conventional roof racks, which may come in a variety of configurations. By integrating the lighting system onto conventional roof rack bars, the lighting system is retained without interfering with cargo loading. Thus the roof rack can be used as it would be normally, while providing the added benefit of illumination and visibility to other drivers.

In an embodiment, the present roof rack lighting system can be combined with individual pieces that make up a conventional roof rack. In particular, the frame of the roof rack can be configured to provide an internal receptacle for, and also structurally protect, the light source of the present system. In an embodiment, the illumination may be provided by a single extending light source, or by an array of multiple light sources in combination with a diffuser in order to provide a continuous illumination. In an embodiment, the light source can alternatively or additionally be covered by a lens, which may also serve as a diffuser, to protect the lights from breaking while the roof rack system is used to carry cargo. In another aspect, a light source integrated into the roof rack functions as a warning, hazard, and/or brake light.

In an embodiment, the present roof rack lighting system may be integrated with a vehicle roof bicycle carrier. Bicycles are a very important means of transportation. Without the use of any fuel bikes can be used for transportation, which is very energy efficient and environmentally friendly. There are generally two conventional types of bicycle carrier. One type attaches to the trunk of a vehicle, and the other type mounts on the roof rack. With a roof rack, two mounting frames are usually mounted transversely from front to back and from left and right on the roof of a vehicle. Thereafter, the front and the rear wheel of the bicycle to be fixed to the mounting frame to hold the bicycle in position on the roof of the vehicle and thus to transport the bicycle to the destination. In an embodiment, the present roof rack lighting system allows for the integration of lighting systems, including brake lights, with bicycle carriers.

In an embodiment, the present roof rack lighting system allows the light source or sources to be incorporated into the front, sides, and/or rear of the roof rack. Accordingly, the integrated lighting system may include warning lights to accompany several other vehicle warning light systems.

In an embodiment, the present roof rack lighting system may utilize a light source along the rear of the roof rack to function as an additional or alternative brake light, typically red in color, which may be accommodated into a receptacle in the roof rack frame. The rear light source may also utilize yellow lights on each respective side of the rear light source to serve as an additional turn signal warning for the vehicle. The side bars of the roof rack may also include such turn signal warnings to warn drivers to the side of the vehicle who cannot see the front or rear turn signals on a typical vehicle.

The present system avoids the abovementioned disadvantages by providing warning or brake lights in location other than at the four corners of the vehicle as well as by providing such lights at an elevated level. Such lights are thereby placed conspicuously at a higher point, yet also integrated within an existing structural component common to many vehicles, which structural component may also serve to protect the light source within the system. The present system allows other road users to clearly see the equipped vehicle from a distance, or from an angle or perspective not typically visible. In this way advantages are achieved and the driving safety is increased.

The present embodiments can be used with a variety of types of roof rack, including bicycle carriers. In some applications, it will be desirable to provide illumination for different areas, including the cargo itself. Further, this invention can be used with the various parts of the roof rack, including mounting frame sections that form the sidebars and crossbars of the roof rack. In other applications, it is not necessary to provide illumination for the driver of the equipped vehicle , but rather the illumination is provided for the benefit of other drivers—to alert them to the presence of the equipped vehicle or its cargo.

### BRIEF DESCRIPTION OF THE DRAWINGS

FIG. 1 shows a perspective view of an assembly of components of the present system, according to an embodiment;

FIG. 2 shows a perspective view of the components of the assembled components of FIG. 1, according to an embodiment;

FIG. 3 shows a side view of the present system installed on a vehicle, according to an embodiment;

FIG. 4 shows a rear view of the present system installed on a vehicle, according to an embodiment;

FIG. 5 shows a side view of the present system installed on a vehicle, according to an embodiment;

FIG. 6 shows a sectional view of a portion of the present system, according to an embodiment;

FIG. 7 shows a side view of the present system installed on a vehicle, according to an embodiment;

FIG. 8 shows a rear view of the present system installed on a vehicle, according to an embodiment;

FIG. 9 shows a side view of the present system installed on a vehicle, according to an embodiment;

FIG. 10 shows a perspective view of an assembly of components of the present system, according to an embodiment;

### DETAILED DESCRIPTION

A roof rack with integrated light or lights is illustrated and described below according to the present embodiments. By integrating light sources into the bars of the roof rack, additional safety and warning lighting may be provided without obstructing cargo mounting on the roof rack, and without damaging the light sources so implemented therewith.

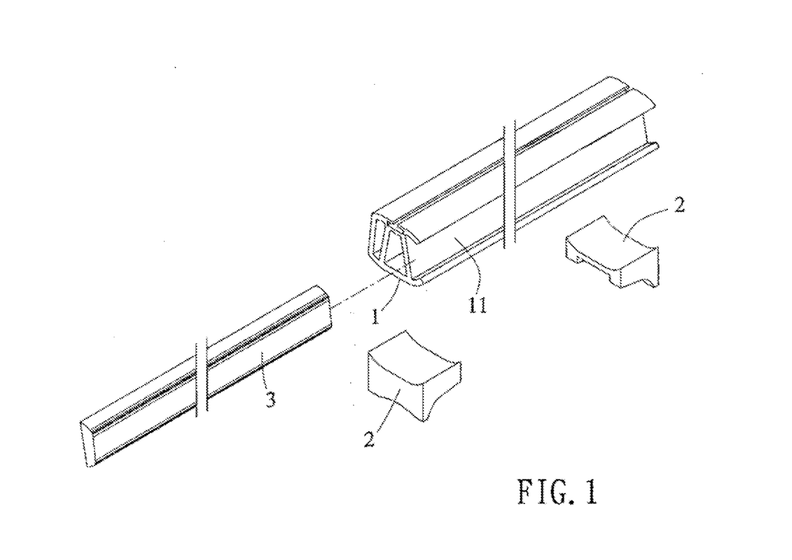

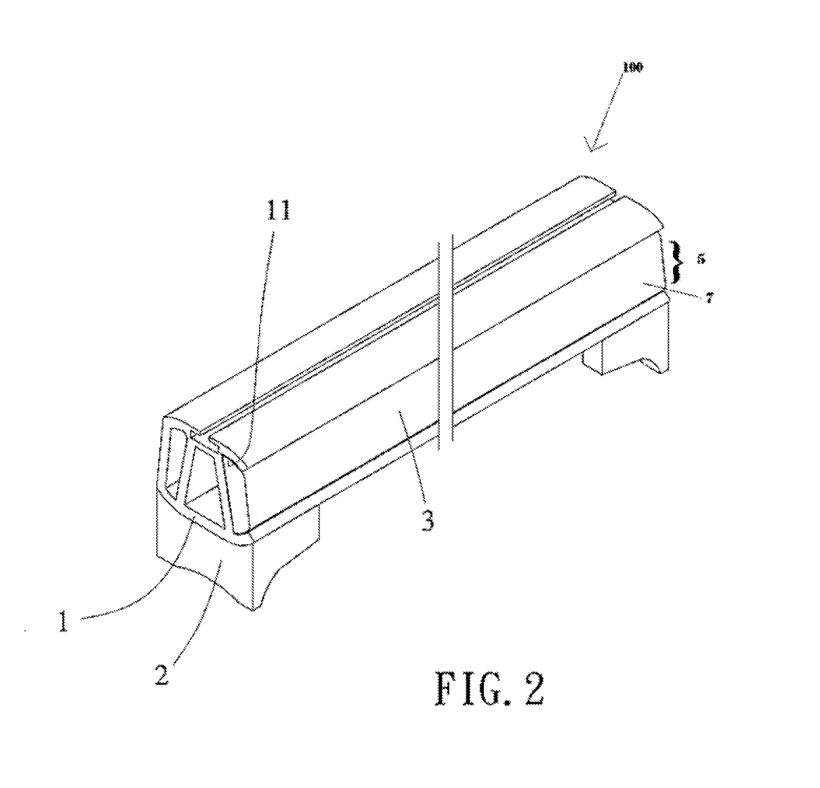

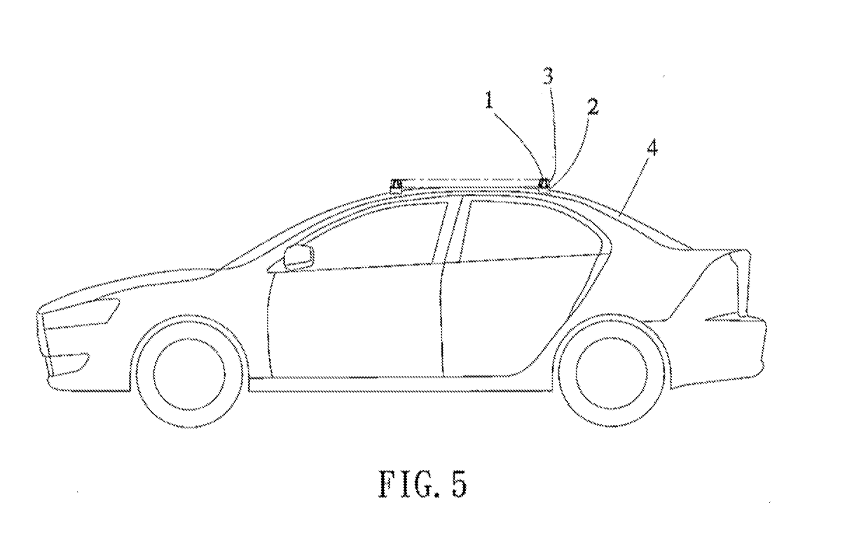

Referring now to FIGS. 1-5, a roof rack lighting system 100 includes a mounting frame 1, which is attached to the roof by an attachment element 2 that connects and attaches the mounting frame 1 to the vehicle or to another section of the roof rack frame. This attachment element 2 can be a portion of the mounting frame 1 configured for attachment to a vehicle 4 (as shown) or it can be a separate piece that attaches the mounting frame 1 to the vehicle 4 or other portions of the roof rack frame.

In an embodiment, the mounting frame 1 contains a receptacle 11 in the side of the mounting frame that is configured to accommodate a light source 3. Within the light source 3, illumination is provided by a lamp (not shown) of a sort suitable for automotive applications, such as halogen, LED, electroluminescent, or florescent. This lamp is configured for connection to a power source (not shown) such as a battery or the vehicle's electrical system (not shown). The outer surface 5 of the light source 3 may include a lens 7 that protects the lamp within the light source 3. Depending on the type of lamp or lamps used, the system may also contain a diffuser (not shown) that can be incorporated with the lens 7, or on either side of the lens. A diffuser allows for more even illumination across the light source even when multiple lamps are used.

The roof rack lighting system 100 can be powered either by being connected to the power system (not shown) of the equipped vehicle 4 or by another power source, for example, a battery (not shown). The particular configuration will depend on the desired application and the power requirements of the particular system.

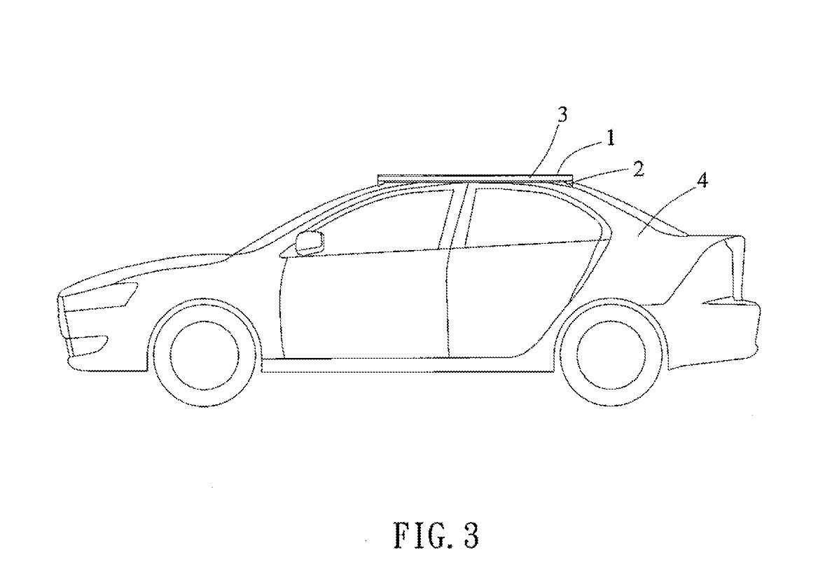

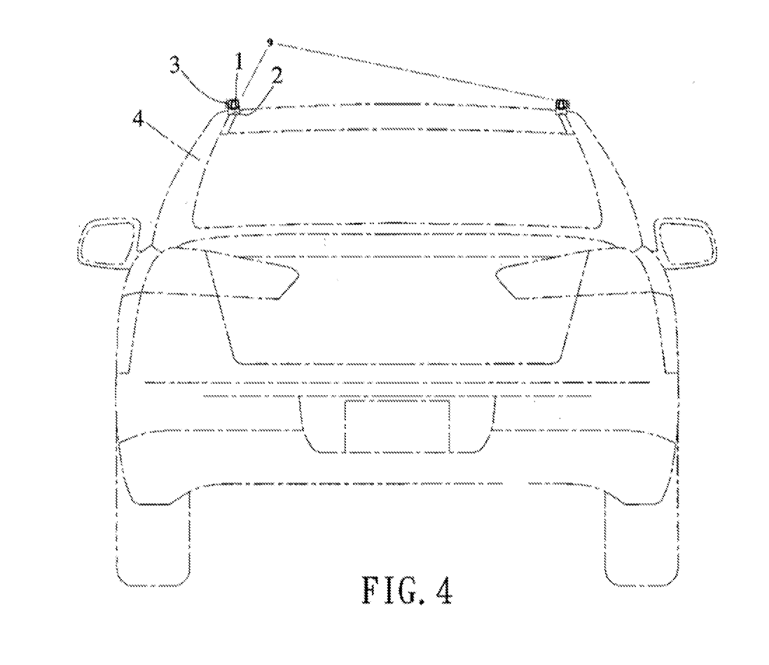

The mounting frame sections 1 can be mounted with light sources 3 facing outward in the sidebars of the roof rack, as best seen in FIGS. 3-4. Alternatively, the system can be mounted so that the light source 3 in the sidebars 9 faces inward in order to illuminate the roof of the vehicle 4, and/or cargo (not shown) secured to the roof rack system 100 above the roof of the vehicle 4.

According to an embodiment, the advantages of the roof rack lighting system 100 of this invention may be best achieved when the light source 3 does not extend above the top of the mounting frame 1 and thus does not obstruct the loading of cargo (not shown).

The use of a receptacle 11 integrated into the mounting frame section 1 allows for the use of light sources 3 much longer than the discrete lights found in the prior art, as discussed above. In an embodiment, the light source 3 may take up the majority of the side of the mounting frame 1. The receptacle 11 and light source 3 may also extend along an entire outer surface 5 (front, sides, and/or rear) of a mounting frame 1. Further, in both sidebars 9 and crossbars 10, the receptacle 11, lens 7, and light source 5 may extend to either or both ends of the bar, allowing light from the light source to shine out from not only the side of the bar but also the ends.

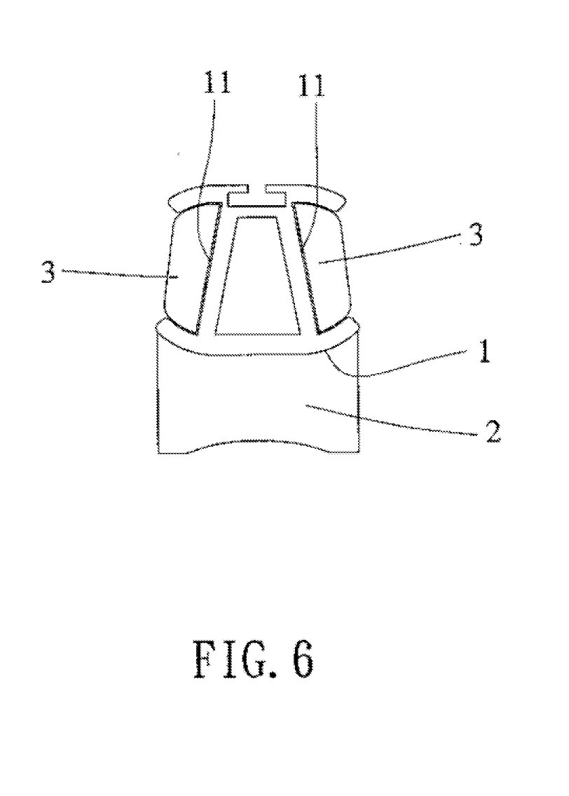

Referring now to FIG. 6, in an embodiment, the roof rack lighting system 100 includes an additional receptacle 11 and light source 3 on the opposite side of the mounting frame 1. As with the other embodiments, these additional components may be used in both crossbars 10 and sidebars 9, and in a variety of applications.

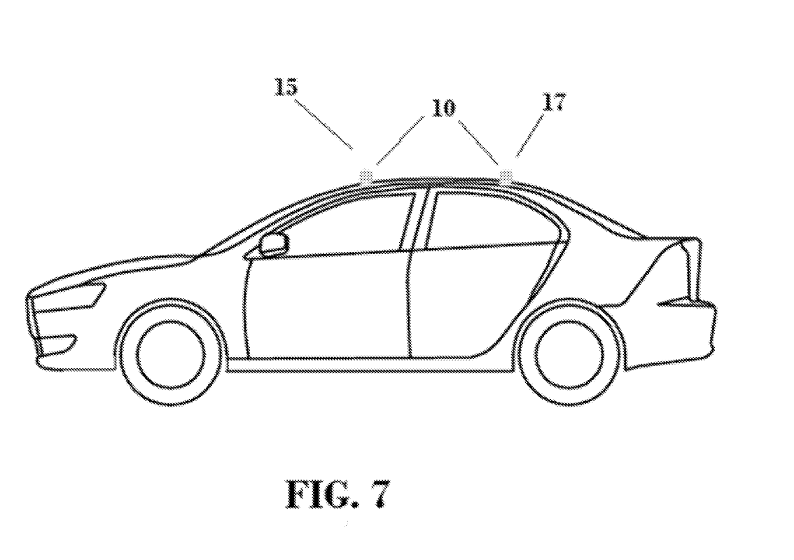

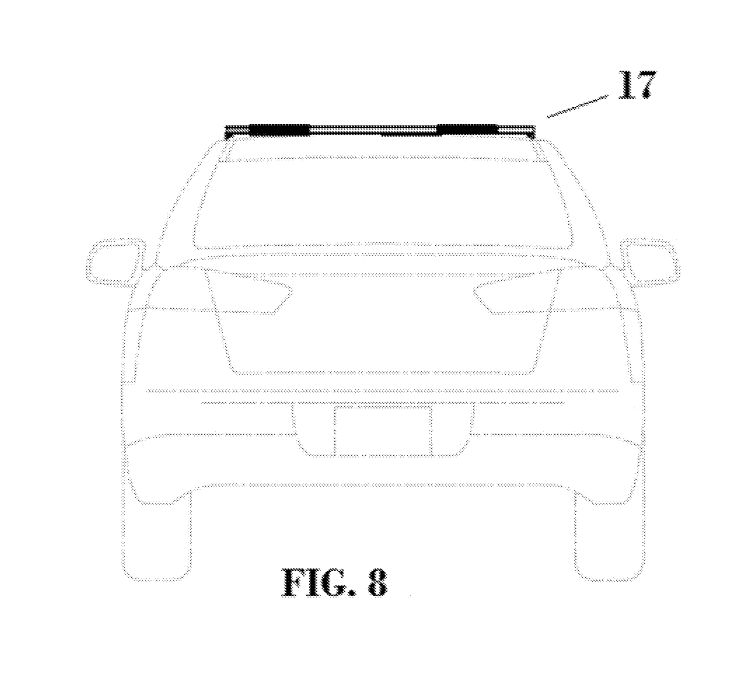

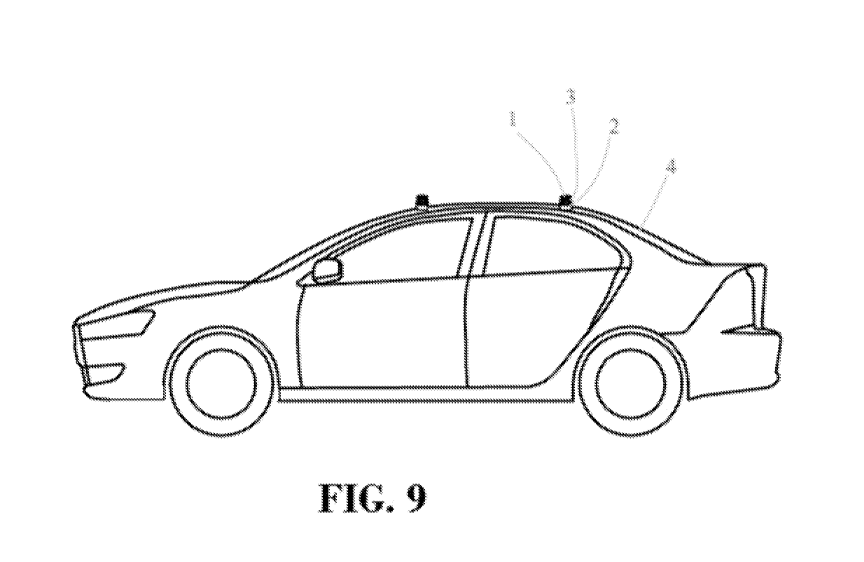

Referring now to FIGS. 1-2 and 7-9, in an embodiment, the roof rack lighting system 100 includes mounting frame sections 1 mounted transversely to the equipped vehicle 4 using the mounting elements 2. In an embodiment, the mounting frame sections 1 may thus form the crossbars 10 of the roof rack with the light sources 3 facing forward and/or backward.

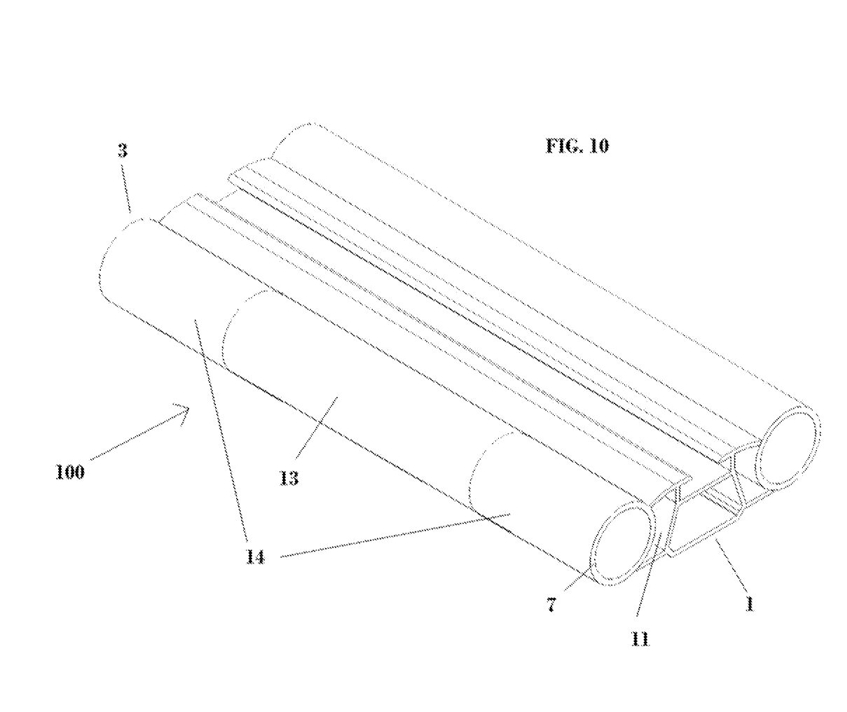

In an embodiment, as best seen in FIG. 10, the roof rack lighting system 100 may function as an additional brake light. According to an embodiment, the system 100 includes a mounting frame 1, which is attached to the roof of the vehicle 4 by an attachment element (not shown) that connects and attaches the mounting frame 1 to the vehicle 4 or to another section of the roof rack frame. The mounting frame 1 contains a receptacle 11 in the side of the mounting frame 1 that can be mounted facing toward the rear of the vehicle 4 that is configured to accommodate a light source 3. Within the light source 3, illumination may be provided by a lamp (not shown) of a sort suitable for automotive applications, such as halogen, LED, electroluminescent, or florescent.

In an embodiment, the outer surface of the light source 3 may include a lens 7 that protects the lamp within the light source. The light source 3 may thus function as a brake light by providing red light either by using red lamps of a type suitable for automotive applications, or by using a red-colored lens or section of lens 13. The lamp should be one capable of producing two brightness levels in order to provide increased intensity when the brakes are applied. Further, the system 100 can be in communication with the braking system (not shown) or associated lighting system of the equipped automobile 4 so the brake light 13 can be illuminated at the correct times. The light source 3 may also be in communication with the hazard warning system (not shown) of the equipped vehicle 4, and thus also function as a flashing hazard warning.

In an embodiment, the roof rack lighting system 100 may include a warning light 14, as best seen in FIG. 10. The warning light 14 may be yellow and this coloration of the illumination can be achieved using either a colored lamp or section of lens 14. According to an embodiment, the warning light or lights 14 may be in communication with the lighting system of the equipped vehicle so the warning light can be illuminated appropriately. The warning lights 14 may be located on the front 15, sides 9, and/or rear bar 17 of the roof rack system 100, and thus additionally function as turn signals, and/or hazard warnings.

The foregoing exemplary descriptions and the illustrative embodiments of the present application have been explained in the drawings and described in detail, with varying modifications and alternative embodiments being disclosed. While the embodiments have been so disclosed, described, and illustrated, it should be understood by those skilled in the art that equivalent changes in form and detail may be made therein without departing from the spirit and scope of the invention, and that the scope of the present invention is to be limited only to the claims except as precluded by the prior art. Moreover, the embodiments as disclosed herein, may be suitably practiced in the absence of the specific elements which are disclosed herein.

What is claimed is:

1. A vehicular roof rack lighting system, comprising:
a mounting frame section, said mounting frame section configured for mounting to a first and a second mounting element;
wherein said mounting frame section has a top, a front, and a rear side;
wherein said mounting frame section comprises a receptacle for a light source within the mounting frame section at the front or rear side;
wherein said light source is configured for connection to a power source;
a translucent lens at the front or rear side of the mounting frame section covering the light source;
wherein said lens covers the majority of the front or rear side of the mounting frame section;
wherein said receptacle is configured to structurally cover and protect by an upper portion of said lens generally parallel to a roof of an equipped vehicle.

2. The vehicular roof rack lighting system of claim 1 further comprising a diffuser.

3. The vehicular roof rack lighting system of claim 1 wherein the translucent lens further comprises a diffuser.

4. The vehicular roof rack lighting system of claim 2 wherein the light source comprises an LED light source.

5. The vehicular roof rack lighting system of claim 1 wherein the light source comprises a fluorescent light source.

6. The vehicular roof rack lighting system of claim 1 wherein the light source comprises a halogen light source.

7. A vehicular roof rack lighting system, comprising:
a mounting frame section, said mounting frame section configured for mounting to a first and a second mounting element;
wherein said mounting frame section has a top, a front, and a rear side;
wherein said mounting frame section comprises a receptacle for a light source at the rear side of the mounting frame section at the front or rear side;
wherein said light source is configured for connection to a power source;
a translucent lens at the rear side of the mounting frame section covering the light source;
wherein said lens covers a portion of the rear side of the mounting frame section;
wherein said receptacle is configured to structurally cover and protect by an upper portion of said lens generally parallel to a roof of an equipped vehicle;
a brake light configured for connection to the braking system of the equipped vehicle.

8. The vehicular roof rack lighting system of claim 7 wherein the brake light comprises a red colored section of said translucent lens.

9. The vehicular roof rack lighting system of claim 7 wherein the brake light comprises a light source that provides primarily red light when illuminated.

10. The vehicular roof rack lighting system of claim 7 wherein the light source is capable of being illuminated to at least two brightness levels.

11. The vehicular roof rack lighting system of claim 7 further comprising a warning light comprising a second light source within said receptacle;
wherein said second light source is configured for connection to a power source;
wherein said warning light is configured for connection to the lighting system of the equipped vehicle.

12. The vehicular roof rack lighting system of claim 11 wherein the warning light comprises a yellow colored section of said translucent lens.

13. The vehicular roof rack lighting system of claim 11 wherein the second light source provides primarily yellow light when illuminated.

14. A method of illuminating a roof rack brake lighting system comprising,
providing a roof rack lighting system according to claim 7;
connecting said light source to an electrical system of the equipped vehicle;
connecting said brake light to said braking system of the equipped vehicle;
illuminating said brake light when the braking system of the equipped vehicle is activated.

15. The method of illuminating a roof rack brake lighting system of claim 14 further comprising:
providing a warning light within said receptacle comprising a second light source;
connecting said second light source to an electrical system of the equipped vehicle;
connecting said second light source to said lighting system of the equipped vehicle;
illuminating said warning light to provide primarily yellow light when the lighting system of the equipped vehicle is activated.
